(19) United States
(12) Patent Application Publication
(10) Pub. No.: US 2020/0175230 A1
(43) Pub. Date: Jun. 4, 2020

(54) METHOD FOR DETERMINING A CONVERSATIONAL AGENT ON A TERMINAL

(71) Applicant: ORANGE, Paris (FR)

(72) Inventors: Arnaud Brun, Chatillon Cedex (FR); Patrick Kirschbaum, Chatillon Cedex (FR)

(21) Appl. No.: 16/696,185

(22) Filed: Nov. 26, 2019

(30) Foreign Application Priority Data
Nov. 29, 2018 (FR) 1872100

(51) Int. Cl. G06F 40/30; G06F 8/61; G06F 9/451

(52) U.S. Cl. CPC G06F 40/30; G06F 9/453; G06F 8/61

(57) ABSTRACT

A method for determining a conversational agent of a human-machine interface on a terminal. The conversational agent is configured to interact with a user of the terminal via the human-machine interface. The method includes: a) upon a server receiving a request for user interaction with the conversational agent, the server calculates at least one personality data item of the user; b) the server selects at least one conversational agent specimen corresponding to the at least one personality data item of the user; and c) the server sends the terminal a response message to the request, the message including the at least one conversational agent specimen.

### BACKGROUND OF THE INVENTION

The present invention relates to the general field of telecommunications. In particular, the invention relates to a method for determining a conversational agent on a terminal of a user.

Currently, many telecommunications solutions are implemented to enable communication between a person and a remote terminal using instant messages via a computer, mobile phone, modem, or any other type of electronic device of a network access provider, for example to the Internet.

Instant messaging-based communication methods and devices are being increasingly explored by the general public and by businesses. In this context, there are known human-machine interfaces driven by conversational agents, called virtual assistants, which are configured to interact with a user via a terminal.

A conversational agent installed on a user's terminal, for example via messaging applications, makes it possible to respond to textual or voice requests from a user. A dialogue can be established between the conversational agent and the user in order to answer questions or implement a particular action.

For example, there are conversational agents specialized in weather forecasting, to answer questions such as “What will the weather be like tomorrow in Paris?”, or conversational agents specialized in home automation, to configure and control remote devices. For example, we can also list conversational agents specialized in reading multimedia content, managing connected objects, ordering goods or services, or communicating with other users.

It is known that interactions with a conversational agent, or with a human-machine interface on a terminal and driven by such an agent, help users to interact quickly and easily with one or more digital platforms, for example to perform specific tasks, search for information, or communicate with other users.

However, because of the ever-increasing number of digital platforms and of users of these platforms, the answers provided by a conversational agent are not always relevant or adapted to the type of requests made by a given user. This results in a loss of time, energy, resources, and convenience for users.

Known conversational agents are in fact programmed to act according to one or more pre-established scripts, which do not take into account the specific context in which the requests of the user are expressed.

For example, a user preparing for a trip abroad is interested in obtaining from a conversational agent a large amount of specific information about his future destination, but will not want to be offered information of the same type upon his return.

Similarly, a user of very open personality may ask a conversational agent to suggest activities or content that are beyond the ordinary, while a user of less open personality expects a conversational agent to propose activities or content in line with his tastes.

There is therefore a need to be able to determine, on a terminal, a conversational agent driving a human-machine interface configured to interact with one or more different users.

In addition, there is a need to optimize the determination of such a conversational agent in order to account for usage patterns, communication habits, or the personality of a given user.

### OBJECT AND SUMMARY OF THE INVENTION

In order to meet this or these needs, a first aspect of the invention relates to a method for determining a conversational agent of a human-machine interface on a terminal, said conversational agent being configured to interact with a user of said terminal via the human-machine interface, said method comprising the following steps:

a) upon the server receiving a request for user interaction with the conversational agent, the server calculates at least one personality data item of the user;
b) the server selects at least one conversational agent specimen corresponding to said at least one personality data item of the user; and
c) the server sends the terminal a response message to said request, said message comprising said at least one conversational agent specimen.

As used herein, a conversational agent is a logic controller configured to respond to messages sent by a user. A conversational agent can interpret commands or keywords comprised in messages it receives. A conversational agent is generally implemented by a computer program executed on an electronic device such as a computer and comprising means adapted to receive and issue commands or instant messages which are textual, voice, or visual.

In the present document, a human-machine interface is any type of system making it possible to connect an individual to a machine and to present data in various forms, for example in a textual, audio, and/or visual manner. It may be a screen integrated into a machine such as a computer screen or a touch pad, a speaker, a holographic projector, etc.

The method for determining a conversational agent according to the invention thus makes it possible to configure a human-machine interface on a terminal of a user on the basis of messages produced or accessed directly by this user. This configuration makes it possible to adapt a conversational agent, and therefore a human-machine interface driven by it, to one or more given users.

In particular, a conversational agent determined by the method of the invention improves the convenience for the user interacting with the corresponding human-machine interface, by saving the energy and resources expended during its use, for example by reducing the number of messages exchanged.

In one embodiment of the invention, the method further comprises a prior reading step by said server of at least one message exchanged by the user in a message box, the calculation step of the method being further implemented by means of a semantic analysis applied to said at least one message, said semantic analysis using a linguistic algorithm applied to the text contained in said message.

Message boxes are used herein. In most cases, a message box is comparable to a database connected to a network. A message box is for example a social network server, a public or commercial database, an Internet page hosting blogs or multimedia content, a digital platform which a user can access via a terminal, or storage memory in which users' messages or emails are stored.

Herein, a semantic analysis is a type of message analysis that makes it possible to establish a significance using the meaning of the elements or words contained therein.

Herein, a semantic analysis may use one or more linguistic algorithms to calculate one or more numerical quantities from text contained in these messages and expressed in natural language.

In one embodiment of the invention, the reading step comprises a substep of a sensor capturing at least one parameter of the user, said parameter being selected among identification data and/or security data.

This makes it possible to adapt the determination of a conversational agent to the identity of the user and to secure the steps of the method on the basis of personal, physical, or biometric characteristics of the user.

In one embodiment of the invention, the response message comprises a combination of said at least one conversational agent specimen, said combination being weighted to reflect the least one calculated personality data item of the user.

This makes it possible to configure a conversational agent according to a plurality of personality characteristics of the user.

In one embodiment of the invention, the reading, calculation, selection, and sending steps are implemented iteratively.

This makes it possible to update a conversational agent regularly, at a frequency adapted to the needs of the user, based on a growing number of messages and user data. With these arrangements, the conversational agent is evolving in nature.

In one embodiment of the invention, the method further comprises a prior step of initialization of the terminal by the user.

This allows defining a default configuration of the terminal, for example for starting the determination process. This prior step also makes it possible to start, from the terminal, a communication between the user and a human-machine interface on the terminal.

In one embodiment of the invention, at least one personality data item of the user comprises at least one numerical parameter, for example an integer greater than or equal to 0 and less than or equal to 10 or 100, said parameter being selected among: a degree of interest, an openness parameter, a conscientiousness parameter, an extraversion parameter, an agreeableness parameter, and a neuroticism parameter.

Herein, a degree of interest is the number of times a user has produced or opened messages about various topics. An openness parameter quantifies a corresponding personality trait of a user concerning his inclination for art, adventure, unusual ideas, curiosity, and imagination. A conscientiousness parameter quantifies a user's personality trait concerning self-discipline, meeting obligations, organization, and goal orientation. An extraversion parameter quantifies a user's personality trait concerning his inclination towards energy, positive emotions, the tendency to seek stimulation and the companionship of others, and the tendency to take initiative. An agreeableness parameter quantifies a user's personality trait concerning his inclination towards compassion for and cooperation with others. A neuroticism parameter quantifies a user's personality trait concerning his inclination towards expressing anger, worry, and depression.

Herein, these parameters can be calculated from the type and the number of words contained in an analyzed message, for example by means of semantic analysis.

The use of these different parameters makes it possible to adapt a conversational agent to the personality of this user, which is stable over time.

In one embodiment of the invention, the personality data item of the user further comprises a mean, a mode, or a median of said at least one numerical parameter comprised in said personality data item of the user.

This allows configuring a conversational agent based on a set of personality data.

In one embodiment of the invention, the sending step comprises a substep of the server of the response message copying the at least one personality data item of the user and/or at least one conversational agent specimen to the terminal or to another server.

This allows the terminal or other server to store in memory a user score or a conversational agent specimen for later reuse. This also allows the terminal or other server to send the user additional information, suggestions, or services from sources other than the server.

In one embodiment of the invention, the personality data item of the user is determined manually by the user.

This makes it possible to more quickly determine a conversational agent from at least one specimen while dispensing with the reading and calculation step.

In one embodiment of the invention, the request is issued by the terminal.

This allows the terminal or the interface to be the source of the communication.

In one embodiment of the invention, the sending step comprises a substep of installing said at least one conversational agent specimen on the terminal or on the server.

This makes it possible to drive a human-machine interface with a conversational agent in a permanent manner.

According to another aspect, the various determination steps according to the invention are implemented by a computer program or software. This program or software is capable of being executed by a computer or by a processor, for example a data processor, this program or software comprising instructions for controlling the execution of the steps of a method for determining a conversational agent. These instructions are storable in a memory of a computing device, for example a server, loaded, and then executed by a processor of that digital device.

This computer program or software may use any programming language, and may be in the form of source code, object code, or intermediate code between source code and object code, such as in a partially compiled form, or in any other desirable form.

In particular, this computer program comprises instructions for executing a method for determining a conversational agent according to any one of the preceding features, taken individually or in any technically possible combination, when said program is executed by a processor.

According to yet another aspect, the invention relates to an information storage medium, removable or non-removable, partially or completely readable by a computer or a microprocessor comprising code instructions of a computer program for the execution of each of the steps of the method according to any one of the preceding features, taken individually or in any technically possible combination.

According to yet another aspect, the invention relates to a server for determining a conversational agent, characterized in that it comprises a processing circuit for implementing the method according to any one of the above features, taken individually or in any technically possible combination. Said server may further comprise software and/or hardware modules, the term “module” corresponding to a software or hardware component, or to a set of hardware and/or software components, capable of implementing a function or a set of functions.

### BRIEF DESCRIPTION OF DRAWINGS

Other features, details, and advantages of the invention will be apparent from reading the following detailed description, and from an analysis of the appended drawings, in which:

FIG. 1 shows a schematic view of an environment comprising a terminal, a human-machine interface on a terminal, a server, and a plurality of message boxes according to one particular embodiment of the invention;

FIG. 2 represents, in flowchart form, an example of the steps of a determination method according to one particular embodiment of the invention;

FIG. 3 represents a schematic view of an example of the calculation, selection, and sending steps of a determination method according to one particular embodiment of the invention; and

FIG. 4 represents a schematic block diagram of a processing circuit for implementing one or more embodiments of the invention.

Unless otherwise indicated, common or similar elements in multiple figures bear the same reference signs and have identical or similar characteristics, so that these common elements are generally not described again for reasons of simplicity.

### DESCRIPTION OF EMBODIMENTS

In the following description, an interaction between a user, a terminal, a human-machine interface of this terminal, and/or a conversational agent driving this interface, consists of an exchange of messages. In addition, the sending and receiving of specific messages makes it possible to cause an internal change of state of these elements. For example, an interaction between a terminal and a server may cause the modification of an internal database of this server or the triggering of a remote control action of an object connected to the terminal by means of a network.

In the following description, different entities are connected to each other via various means, for example via a wired connection such as Ethernet or PLC, a wireless connection such as WiFi or Bluetooth, or any other type of connection which may vary depending on the preferred hardware for implementing the invention.

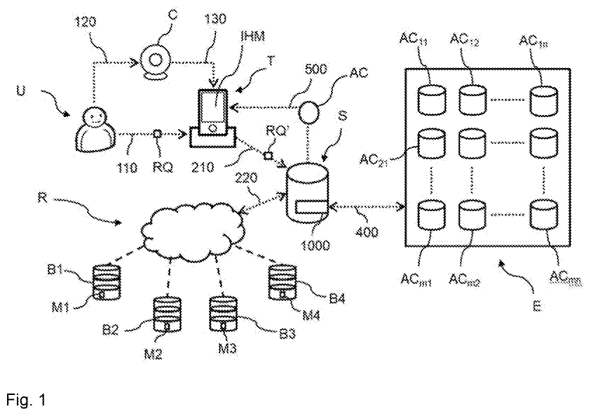

An embodiment of the invention is now described with reference to FIG. 1, which schematically represents an environment that makes it possible to implement a method for determining a conversational agent, this environment comprising in particular a terminal T of a user U, a human-machine interface IHM installed on this terminal T, a server S, and here four message boxes B1, B2, B3, B4.

The terminal T is an electronic device, for example a desktop computer, a laptop computer, a wireless connection device, a mobile phone, a tablet, a watch, a bracelet, or any type of connected object.

The terminal T preferably comprises an interactive system configured to enable the human-machine interface to receive textual or voice messages from a user U and to communicate with the user by means of textual or voice messages.

The server S is a device configured to be connected to one or more terminals as well as to databases. The server S further comprises a circuit 1000 for processing information which will be described below. The server S is connected to the terminal T and to a plurality of message boxes that can differ in number, location, and type.

According to one embodiment of the invention, the server S is connected to at least one message box. The message boxes are accessible by various means, in particular by the server S and the terminal T or any other electronic device of the user U, in order to produce or to access content. As an example, four message boxes B1, B2, B3 and B4 are considered here, each box comprising a corresponding message M1, M2, M3 and M4.

Herein, a message may be any textual or multimedia data. Preferably, this message comprises a textual or multimedia data item selected among: a message exchanged via a communication network, a comment on a network, a video, an image, or a sound. A message exchanged via a communication network is for example an email, an instant message (SMS), or a tweet.

The messages comprised in the message boxes can therefore be of different types, for example text messages, voice messages, or multimedia content from which text can be obtained using known techniques. A message, when it is not textual data, may comprise words expressed in natural language format and can be extracted by various known means. For example, converters are known that are capable of extracting text from a video, or of recognizing characters or words in an image, regardless of the language used.

In a non-limiting manner, for example, box B1 is a box of messages written by the user U, comprising emails, SMS messages, or comments left on a social network. Box B2 is for example a memory where weather forecasts accessed by the user are stored, box B3 is a server comprising telecommunications news articles to which the user contributes, and box B4 is a device issuing notifications concerning traffic conditions in the vicinity of the user.

As shown in FIG. 1, a user U establishes, during a launch substep 110, a communication with a terminal T on which a human-machine interface IHM is installed.

The communication established by the user during this launch substep 110 can be initiated for example by means of a request RQ from the user U sent to the terminal T. Such a request may be textual or voice in nature, and may comprise different types of data, such as a question formulated by the user U or a command to turn on a device.

Examples of different types of requests include: voice input, text input, biometric data, a click, or a combination of these. Voice input can be received from mobile devices such as a phone, tablet, microphone, headset, car voice system, messaging, etc. Text input can be received from computer or mobile keyboards, remote controls, emails, instant messages, search texts, and other textual interactions via electronic devices of any type.

According to one embodiment, not shown, the launch substep 110 comprises the sending of a request from the interface IHM or from the terminal T to the user U, for example a communication request that asks for user identification.

According to one embodiment of the invention, a sensor C captures data, during a capture substep 120, which it then sends to the terminal T during a transmission substep 130. The captured data are, for example, data from the user U. The sensor C is distinct from the terminal T and may be a keyboard, mouse, camera, biometric device such as a fingerprint reader, or any other type of sensor configured for identifying the user U.

This capture substep 120 makes it possible to include additional data in the request RQ sent to the server S that are useful for identifying the user U from other users, for example on the basis of personal information or physical characteristics, or biometrics.

In a variant, the data captured during the capture substep 120 may be sent directly from the sensor C to the server S without passing through the terminal T.

In the determination method according to the invention, the request RQ is a request for a proposal of a conversational agent of the user U. A user U may for example ask the terminal to determine a conversational agent AC that corresponds to him.

According to one embodiment of the invention, the request comprises other parameters associated with the user U, for example identification data LOG and/or security data such as a password PWD.

When the message exchanged during substep 110 includes such a request RQ, the terminal T transfers it to the server S, possibly in the form of a modified request RQ′. This transfer is implemented during a transfer substep 210. The modified request RQ′ can be distinguished from the initial request RQ in that it comprises additional information, for example predetermined information relating to the terminal T or to the interface IHM. This prevents the user U from having to provide this information systematically in his requests.

Upon receipt of the request RQ or the modified request RQ′, the server S accesses the message boxes B1, B2, B3, B4 during a communication substep 220. During this communication substep 220, the server S also reads one or more messages in these boxes, for example messages M1, M2, M3, M4 produced or viewed by the user U. Preferably, the communication substep 220 is implemented via the network R.

As illustrated in the figures, and according to substeps 110, 120, 130, 210 and 220, a calculation step 300, a step 400 of selecting a conversational agent AC from a set E of specimens AC11, AC21, . . . ACm1, ACm2, . . . , ACmn, and a step 500 of sending said agent AC from the server S to the terminal T, are implemented.

According to one embodiment of the invention, said conversational agent specimens form part of a set E located on the server S. Each of the conversational agent specimens may be associated with a personality data item of the user.

Alternatively, the set E is located on a server separate from server S and connected to said server S.

According to one embodiment of the invention, the set E comprises at least as many conversational agent specimens as there are possible values for the personality data item of the user.

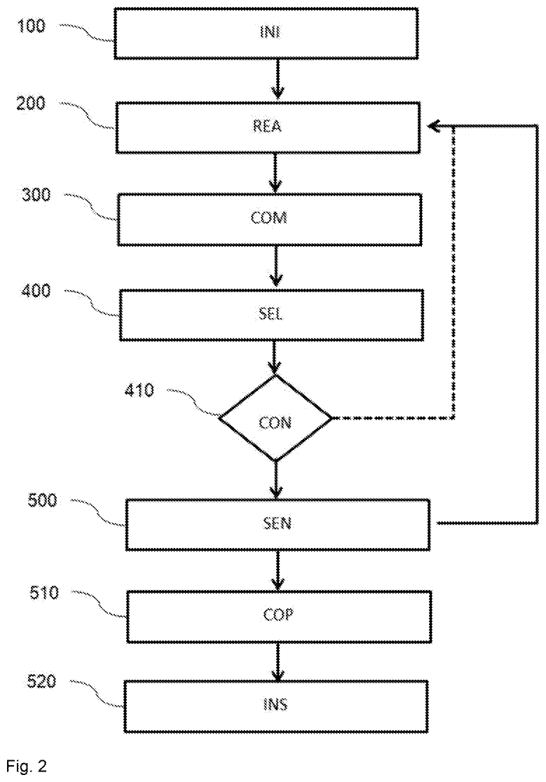

FIG. 2 represents, in flowchart form, several steps of a determination method according to one embodiment of the invention.

According to one embodiment of the invention, the method comprises a step 100, INI, called the initialization step, which comprises the launch substep 110, the capture substep 120, and/or the transmission substep 130 which are described above.

The method further comprises a step 200, REA, called the reading step, which is implemented upon the server S receiving a request RQ for a proposal of a conversational agent.

The reading step 200 comprises in particular the transfer substep 210 and the communication substep 220 described above. The reading step 200 may also comprise a capture substep.

During the reading step 200, the server S accesses at least one message box chosen among boxes B1, B2, B3, B4 and reads one or more messages M1, M2, M3, M4 exchanged by the user U in each of these.

For example, the server S connects to box B1 and reads email M1 of the user U sent by the terminal T and stored in box B1, the server S connects to box B2 and reads a weather report M2 viewed by the user U, the server S connects to box B3 and reads an article M3 written by the user U in the field of telecommunications news, and the server S connects to box B4 and reads a notification M4 of traffic conditions in the Paris region. During substep 220, messages M1 to M4 may be partially or entirely copied to the server S for analysis purposes, in a secure manner and with the user's authorization.

To access this or these messages, the server S may use a parameter provided by the user such as identification data LOG and/or security data PWD, for example when secure access is required to read the messages. The message is possibly copied to the server during the reading step 200, or is viewed read-only in order to limit data sharing.

The method further comprises a step 300, COM, called the calculation step, which is implemented continuously or on an ad-hoc basis by the server S after it has accessed at least one message.

During the calculation step 300, the server calculates at least one personality data item of the user associated with one or more messages read during the reading step 200.

For example, the server S determines a personality data item Z1 of the user associated with message M1, a personality data item Z2 of the user associated with message M2, etc. Alternatively, the server S can determine a single personality data item of the user associated with the combination of all messages read in substep 220.

According to one embodiment of the invention, this determination is made by means of a semantic analysis, which is applied to the texts contained in the messages read by the server S, for example based on a predetermined dictionary of words or combinations of words.

This semantic analysis can be done through the application of various known linguistic algorithms. These algorithms identify for example the number of terms, synonyms, keywords, and/or expressions related to a given topic. The results provided by these algorithms make it possible to quantify information contained in a message produced or accessed by a given user.

Advantageously, such a semantic analysis makes it possible to quantify information contained in a message produced or accessed by a given user.

The identified terms may be stored in advance in one or more linguistic databases accessible by the server S, which compares them with the terms used in the message and calculates a personality data item of the user, in real time or in a deferred manner, associated with each analyzed message. These linguistic databases may be updated regularly or occasionally.

When these elements are identified, each of the messages is viewed as defining one or more numerical parameters, said parameters being able to be associated with the user since the user has produced or accessed these messages. These numerical parameters may be of different types, for example a number quantifying a personality trait or a read time of content of the user U. The value of this number may depend on the density and/or the topic of the elements identified in the text.

As a variant, the user U may himself determine, by means of the terminal T, the value of these numerical parameters or of the user's personality data item. Advantageously, such manual determination allows the user's personality data item not to depend on the user's messages, and therefore allows the user U to directly select a conversational agent from conversational agent specimens.

According to one embodiment of the invention, a personality data item of the user comprises several numerical parameters.

According to a first example, a calculation of a personality data item of a user can be done on the basis of interest levels concerning online news articles, weather forecasts, general culture blogs, scientific documents, etc. Based on the analysis of these user messages, we can consider three degrees of interest of the user, and establish that 70% of these messages concern requests for information related to weather forecasts, 20% concern comments on a telecommunications news site, and 10% concern notifications of traffic conditions in his vicinity. A personality data item of the associated user that can be established is for example ( 7/10, 2/10, 1/10).

According to a second example, a calculation of a personality data item of the user can be done on the basis of technical parameters characterizing messages produced or viewed by the user. Thus, a given message may have a given length, language, tone, or mode of presentation. These technical parameters can therefore also characterize the messages sent by a conversational agent driving a human-machine interface that interacts with a user. If a user interacts with a conversational agent via short text messages, this conversational agent may be determined such that it responds via messages of similar length. If a user interacts via male voice messages, the corresponding conversational agent can be determined via voice messages which are also male, etc.

According to a third example, a calculation of a personality data item of the user can be done on the basis of personality traits defined in the form of five numerical parameters, defined on the basis of an empirical model called “Big 5”.

According to this “Big 5” model, the personality traits of a user U can be quantified according to five numerical parameters which are an openness parameter, a conscientiousness parameter, an extraversion parameter, an agreeableness parameter, and a neuroticism parameter.

In the case of the “Big 5” model, each of these parameters is an integer greater than or equal to 1 and less than or equal to 5. The value of these parameters thus defines a score from ⅕ to 5/5 evaluating the importance of the corresponding personality trait of the user U. For example, a minimum score (⅕) for the extraversion parameter corresponds to a very introverted user and the maximum score (5/5) corresponds to a very extroverted user.

According to one variant, the value of these parameters is an integer greater than or equal to 0 and less than or equal to 10. According to another variant, the value of these parameters is an integer greater than or equal to 0 and less than or equal to 100, etc.

At the end of the calculation step 300, the server S has, associated with each message or with all the messages, at least one personality data item of the user.

The method further comprises a step 400, SEL, called the selection step, in which the server S implements a selection of at least one conversational agent specimen corresponding to one or more personality data items of the user which were calculated during the calculation step 300.

In a non-limiting manner, a conversational agent specimen is a conversational agent for which the personality data item of the corresponding user is predefined.

According to one embodiment of the invention, the server S accesses a set E, for example located in a storage memory of said server S, comprising a plurality of conversational agent specimens AC11, AC21, . . . , ACm1, ACm2, . . . , ACmn, it being possible to combine several of these specimens together to form a single agent AC for which the personality data item of the corresponding user is weighted to reflect the personality data of said specimens.

Thus, for example, a conversational agent AC may be formed by the combination of four specimens AC11, AC22, AC33, and AC44 corresponding to the user's respective personality data ⅕, ⅕, ⅗, and 5/5. The conversational agent AC may be the result of any desired weighting for these four specimens, for example 10%, 10%, 30%, and 50%. In another example, the conversational agent AC may be formed by a single specimen for which the user's personality data are ⅕, ⅕, ⅗, and 5/5, respectively.

One possibility for achieving this weighting is to include the calculation of a measure of central tendency, for example a mean, a mode, or a median of the personality data of the user of the specimens. In the case of a mean, the conversational agent formed by the combination of the above four specimens thus corresponds to a user's personality data item of ½; in the case of a mode, the conversational agent corresponds to a user's personality data item of ⅕; and in the case of a median, the conversational agent corresponds to a user's personality data item of ⅗.

In the selection step 400, the server S chooses, from a set E, one or more conversational agent specimens for which the user's personality data correspond to the data calculated during the calculation step 300.

As described above, this choice is made from a set E of conversational agent specimens, this set comprising, for example, the specimens AC11, AC21, . . . , ACm1 associated with a given type of message box B1. For example, specimens AC11, AC21, . . . , ACm1 are conversational agents associated with emails or with commands for connected objects in the home of user U.

These specimens AC11, AC21, . . . , ACm1 may each be associated with a different value for at least one numerical parameter of the user's personality data item. For example, specimen AC11 may differ from specimen AC21 in that their extraversion parameters are ⅕ and ⅖ respectively. Or, specimen AC11 can be distinguished from specimen AC21 by the different values of their degrees of interest, for example their degree of interest for notifications relating to traffic conditions in the vicinity of the user are respectively 1/10 and 2/10, etc.

Preferably, the set E comprises at least as many conversational agent specimens as there are possible values of personality data of the user.

It will be understood here by corresponding personality data of the user that the one or more specimens selected in step 400 are those presenting a user's personality data item that is sufficiently numerically close to at least one personality data item of the user calculated in step 300.

In one particular case, corresponding personality data of the user is understood to mean that the one or more specimens selected during step 400 are those for which the value of at least one numerical parameter is closest to the value of the corresponding numerical parameter of the personality data item of the user calculated during step 300. For example, a selection of a specimen from a set E of three specimens AC12, AC13 and AC14 for which the user's personality data are respectively ⅖, ⅗ and ⅘ involves selecting specimen AC12 if the calculated personality data item of the user is ⅕, specimen AC13 if the calculated personality data item of the user is ⅗, and specimen AC14 if the calculated personality data item of the user is 5/5.

According to one embodiment of the invention, at the end of the selection step 400, a confirmation substep 410, CON, similar to the capture substep 120 and triggered by the server S, may be implemented in order to verify that the user U of the terminal T for which a conversational agent AC is determined is the same user as the one who sent the initial request RQ. If not, for example if the fingerprints of the user captured during substep 410 do not correspond to the fingerprints of the user U captured during substep 120, then the determination method reapplies at least one of the steps of the method, for example the reading step 200, or alternatively stops and sends no response message to the request RQ.

The method further comprises a step 500, SEN, called the sending step, during which the server S communicates to the terminal T a response message to the request RQ, this response message comprising a combination of at least one conversational agent specimen selected during the selection step 400.

Once received by the terminal T, the combination AC constitutes the conversational agent determined for the user U for driving the interface IHM on said terminal and for interacting with said user U.

According to one embodiment of the invention, the sending step 500 comprises a substep 510 of the server S copying at least one response message or at least one conversational agent specimen to entities distinct from the server.

According to one embodiment of the invention, the sending step 500 further comprises a substep 520 of installing the combination AC on the terminal T or on the server S.

According to one embodiment of the invention, the reading 200, calculation 300, selection 400, and sending 500 steps are implemented iteratively.

Advantageously, the iterative implementation of these steps allows regularly updating a conversational agent AC based on an increasing number of messages of the user. It is thus possible to adapt the determination of the agent AC on the basis of an increasing amount of data.

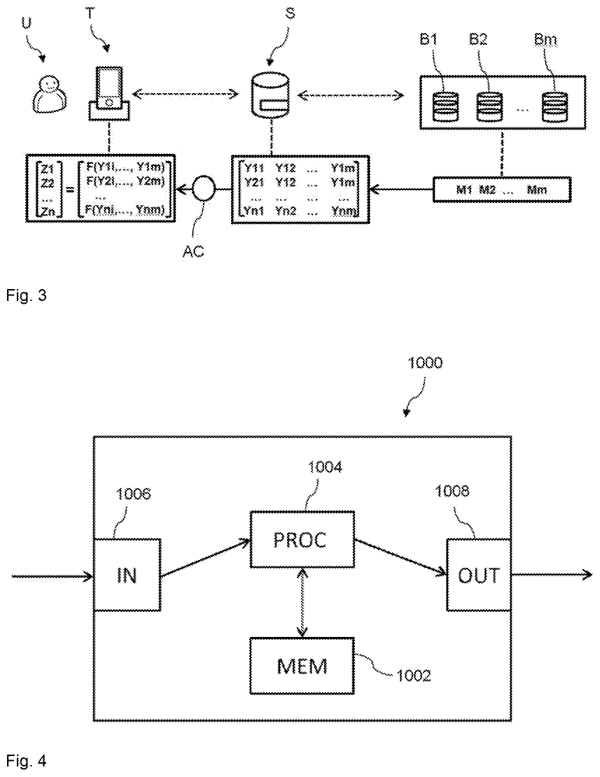

FIG. 3 illustrates a schematic view of an example of the calculation, selection, and sending steps of a determination method according to one particular embodiment of the invention.

When a request is sent from the terminal T of the user U and received by the server S, the server S accesses messages M1, M2, . . . , Mm located in different message boxes B1, B2, . . . , Bm.

During the calculation step, the server S calculates, for each accessed message, several numerical parameters associated for example with his tendency to openness, conscientiousness, extraversion, agreeableness, and neuroticism.

For example, to message M1 will correspond five parameters Y11, Y21, Y31, Y41 and Y51, to message M2 will correspond five parameters Y12, Y22, Y32, Y42 and Y52, to message M3 will correspond five parameters Y13, Y23, Y33, Y43 and Y53, and to message M4 will correspond five parameters Y14, Y24, Y34, Y44 and Y54, each parameter defining a score ranging from ⅕ to 5/5.

Based on all these parameters, the server S derives a personality data item of the user comprising five numerical parameters Z1, Z2, Z3, Z4 and Z5. Parameter Z1 is for example the result of applying a function F to the parameters Y11, Y21, Y31, Y41 and Y51 corresponding to message M1, and so on for parameters Z2, Z3, Z4 and Z5.

Advantageously, the number of numerical parameters comprising each personality data item of the user can be reduced to a single numerical parameter by means of a mathematical function depending on these parameters, for example by calculating the average, the mode, or the median of these parameters. The function F can be for example a mathematical average of the variables on which it depends, so that Z1 equals the sum Y11+Y21+Y31+Y41+Y51 divided by five, and so on for parameters Z2, Z3, Z4 and Z5.

The server S then selects, from a plurality of conversational agent specimens, one or more of these specimens combined to the height of the user's personality data item Z comprising Z1, Z2, Z3, Z4 and Z5.

According to a first example, three messages M1, M2 and M3 of the user U are accessible in a message box B1 by the server S, these being associated with a personality data item of the user, this user's personality data item comprising three parameters quantifying the degree of interest of the user U in telecommunications news, in weather forecasts, and in traffic conditions in his vicinity. Message M1 can thus have the scores (⅙, 2/6, 3/6), message M2 can have the scores ( 3/6, 2/6, ⅙), and message M3 can have the scores ( 2/6, 2/6, 2/6). The server S can in this case calculate a personality data item of the user that is equal to (⅓, ⅓, ⅓), these parameters being the averages of these scores. The server S then determines a conversational agent AC resulting from the combination of a weighted combination of specimens to the height of that user's personality data item, for example a conversational agent AC comprising three conversational agent specimens: an agent specimen AC11 dedicated to telecommunication news agent for a fraction equal to ⅓, an agent specimen AC12 dedicated to weather forecasting for a fraction equal to ⅓, and a agent specimen AC13 dedicated to traffic conditions for a fraction equal to ⅓.

According to a second example, two messages M1 and M2 of the user U are separately accessible in two message boxes B1 and B2 by the server S, each of them associated with a personality data item of the user comprising five numerical parameters which are openness, conscientiousness, extraversion, agreeableness, and neuroticism. Message M1 can thus have the scores (⅕, ⅕, ⅕, ⅕, 5/5) and message M2 can have the scores (⅕, ⅕, 5/5, ⅗, ⅕). The server S can in this case calculate a personality data item of the user equal to (⅕, ⅕, ⅗, ⅖, ⅗), in which the parameters are the averages of these scores. The server S then determines a conversational agent AC resulting from the combination of a weighted combination of specimens at the height of that personality data item of the user, for example a conversational agent AC comprising a single agent specimen whose five numerical parameters are equal to the one calculated. The conversational agent AC thus determined may present personality trait parameters averaging those of the user U as measured from the content of the two messages M1 and M2.

Advantageously, an interface IHM driven by a conversational agent AC having 20% extraversion can be configured to interact very little with the user and, for example, will only respond to user demands. For example, to the question “What are the traffic conditions this Monday morning in Paris?”, the interface IHM will simply answer “very bad” and will not ask any questions to continue the exchange with the user and will not make any spontaneous proposal. Conversely, an interface IHM driven by a conversational agent AC with 90% extraversion interacts very strongly with the user, meaning that it responds more extensively to user questions and can make multiple proposals. To the same question “What are the traffic conditions this Monday morning in Paris?”, the agent can answer: “Today's a strike day, your usual driving routes are blocked, and snow is making the roads impassable; it is advisable to use the metro instead; would you like to receive notifications of metro schedules suitable for an imminent departure?” and may even initiate user exchanges such as “Would you rather stay at home and watch an action movie?” etc.

Thus, an introverted user will communicate more fluidly and efficiently with a conversational agent that has been determined so as to strictly limit its response to user requests, while an extroverted user will interact more extensively and more effectively with a conversational agent which itself initiates communications or offers a more developed response to the same requests.

FIG. 4 illustrates, according to one particular embodiment of the invention, a device 1000 for implementing the determination method.

The device 1000, which is preferably an integrated circuit, is comprised in the server S. The device 1000 may also be integrated into the terminal T or into any other electronic device distinct from the terminal T and server S.

The device 1000 comprises a storage space 1002, for example a memory MEM, and a processing unit 1004 equipped for example with a processor PROC. The storage space 1002 is for example a non-volatile memory (ROM or Flash, for example), and may constitute a storage medium, this recording medium further able to comprise a computer program. When it constitutes a storage medium, the storage space 1002 can be read by the server S.

The device 1000 further comprises a communication module enabling said device to connect to a telecommunications network, for example to network R, and to exchange data with other devices via said telecommunications network. For example, the communication module may be an Ethernet or Wifi network interface, or a Bluetooth communication module.

The communication module of the device 1000 comprises a data receiving module 1006, for example a receiver IN, and a data transmission module 1008, for example a transmitter OUT.

Module 1006 is configured to receive a request for connecting or disconnecting the device 1000, coming from the terminal T, another server, or any other electronic device. In particular, module 1006 is configured to receive a request for a proposal of a conversational agent and one or more messages read in a message box which the device 1000 can access via a telecommunications network.

Module 1008 is configured to issue a connection request to the terminal T, to another server, or to any other electronic device. In addition, module 1008 is configured to send to the terminal T a response message to the request received by module 1006, for example a message comprising a conversational agent specimen or a weighted combination of such specimens.

The storage space 1002, which may be secure, is configured for saving and storing any data read by module 1006, processed by unit 1004, and/or sent by module 1008.

The processing unit 1004, which can be controlled by a program, is configured to implement the determination method as described in the invention with reference to FIG. 2.

At initialization, the instructions of a program to control the processing unit 1004 are, for example, loaded into a random access memory (RAM, for example), not shown, comprised in the device 1000, before being executed by the processor of the processing unit 1004.

In particular, the processing unit 1004 is configured to implement calculation steps, in particular a calculation of at least one personality data item of the user for a message read by the receiving module 1006, this calculation being done by means of a semantic analysis as described above.

In addition, the processing unit 1004 is configured to select one or more conversational agent specimens. This or these specimens are for example specimens stored in the storage space 1002, and the selection of at least one of these specimens can be done so that this selection corresponds to at least one calculated personality data item of the user.

1. A method for determining a conversational agent of a human-machine interface on a terminal, said conversational agent being configured to interact with a user of said terminal via the human-machine interface, wherein said method comprises:
a) upon receipt, by a server, of a request for user interaction with the conversational agent, computing, by the server, at least one personality data item of the user;
b) selecting, by the server, at least one conversational agent specimen corresponding to said at least one personality data item of the user; and
c) sending, by the server, a response message to said request, said message comprising said at least one conversational agent specimen.

2. The method according to claim 1, wherein the method further comprises prior reading, by said server, of at least one message exchanged by the user in a message box, the computing being further implemented by a semantic analysis applied to said at least one message, said semantic analysis using a linguistic algorithm applied to the text contained in said message.

3. The method according to claim 2, wherein the reading comprises acquiring, by a sensor, at least one parameter of the user, said parameter being selected among identification data and/or security data.

4. The method according to claim 1, wherein the response message comprises a combination of said at least one conversational agent specimen, said combination being weighted by the at least one calculated personality data item of the user.

5. The method according to claim 1, wherein the computing, the selecting, and the sending are implemented iteratively.

6. The method according to claim 1, wherein the method further comprises a prior initialization of the terminal by the user.

7. The method according to claim 1, wherein said at least one personality data item of the user comprises at least one numerical parameter, said at least one numerical parameter being selected among: a degree of interest, an openness parameter, a conscientiousness parameter, an extraversion parameter, an agreeableness parameter, and a neuroticism parameter.

8. The method according to claim 7, wherein the personality data item of the user further comprises a mean, a mode, or a median of said at least one numerical parameter comprised in said personality data item of the user.

9. The method according to claim 1, wherein the sending comprises copying, by the server, the at least one personality data item of the user and/or at least one conversational agent specimen to the terminal or to another server.

10. The method according to claim 1, wherein the personality data item of the user is determined manually by the user.

11. The method according to claim 1, wherein the request is issued by the terminal.

12. The method according to claim 1, wherein the sending comprises installing said at least one conversational agent specimen on the terminal or on the server.

13. (canceled)

14. A non-transitory computer-readable storage medium having stored thereon instructions of a computer program comprising instructions, which when executed by a processor of a server configure the server to determine a conversational agent of a human-machine interface on a terminal, said conversational agent being configured to interact with a user of said terminal via the human-machine interface, wherein the instructions configure the server to:
a) upon receipt, by a server, of a request for user interaction with the conversational agent, compute, by the server, at least one personality data item of the user;
b) select, by the server, at least one conversational agent specimen corresponding to said at least one personality data item of the user; and
c) send, by the server, a response message to said request, said message comprising said at least one conversational agent specimen.

15. A server for determining a conversational agent of a human-machine interface on a terminal, said conversational agent being configured to interact with a user of said terminal via the human-machine interface, said server comprising:
a processing unit configured to compute at least one personality data item of the user upon receipt, by the server, of a request for user interaction with the conversational agent, and to select at least one conversational agent specimen corresponding to said at least one personality data item of the user; and
a communication module configured to send a response message to said request, said response message comprising said at least one conversational agent specimen.

16. The method according to claim 7, wherein said at least one numerical parameter is an integer greater than or equal to 0 and less than or equal to 100.

17. The method according to claim 16, wherein said at least one numerical parameter is greater than or equal to 0 and less than or equal to 10.
